(19) United States
(12) Patent Application Publication
(10) Pub. No.: US 2015/0004522 A1
(43) Pub. Date: Jan. 1, 2015

(54) Modified planar cell (MPC) and electrochemical device battery (stack) based on MPC, manufacturing method for planar cell and battery, and planar cell embodiments

(71) Applicants: Aleksandr S. Lipilin, UrO Ran (RU); Viktoria S Liplina, UrO Ran (RU)

(72) Inventors: Aleksandr S. Lipilin, UrO Ran (RU); Viktoria S Liplina, UrO Ran (RU)

(21) Appl. No.: 14/367,916

(22) PCT Filed: Dec. 20, 2012
(86) PCT No.: PCT/IB2012/002774

§ 371 Date: Jun. 22, 2014

(30) Foreign Application Priority Data
Dec. 22, 2011 (EP) 11 010 138.3

(51) Int. Cl. H01M 8/12; H01M 4/86

(52) U.S. Cl. CPC H01M 8/122; H01M 4/8605; H01M 8/1253; H01M 2300/0077; H01M 2008/1293
USPC 429/480; 429/482; 264/328.2; 425/189

(57) ABSTRACT

The invention relates to a modified planar cell with a solid-oxide solid electrolyte, a gas-diffuse anode, a cathode, a metal or oxide current path and a current-gas supply. The supporting solid electrolyte of the cell is in the form of a corrugated plate consisting of corrugations. In cross-section, the corrugations of the plate constitute an isosceles, identical-height trapezium, without a larger lower base with holes. The holes are formed on one side in the upper part of each corrugation, for supplying one of the reagents, e.g. fuel in case of a fuel cell. The corrugations are connected to one another at their base in order to form gas space channels of the cell. The gas space channels are in the form of inverted isosceles trapezia without a larger upper base and the angle α at their smaller base is 0.1 to 89.9°. The corrugated plate is connected to two opposing walls, a front wall and a rear wall. The latter is arranged perpendicular to the corrugations of the plate and thus of equal height, and is furnished with holes. The holes in one wall are used for introducing a second reagent, e.g. air in the case of a fuel cell, into each channel of the electrode environment in the form of inverted isosceles trapezia without the larger upper base and the holes of the other opposing wall for discharging the hypoxic mixture. On one side of the gas space channels constituting, in cross-section, an isosceles trapezium without larger lower base, the corrugated plate of the supporting solid electrode is coated with an electrode, e.g. a nickel-cermet anode in the case of a fuel cell. On the side of the gas space channels of the electrode environment, which are shaped in the form of inverted isosceles trapezia without the larger upper base, the plate is coated with a second, counter-electrode, e.g. a cathode based on strontium-lanthanum-manganite. The metallic box-like gas supply duct ensures the supply of reagents and the discharge of reaction products with a series of holes. The width and the length of the gas supply duct coincide with those of the cell. These holes correspond to the holes in the upper parts of the corrugations of the cell that constitute, in cross-section, an isosceles trapezium without a larger lower base and are connected in a gas-tight manner to the periphery of the holes. A gas-tight space is formed in the planar cell for the reagent introduced via a tube, for the uniform distribution thereof via the gas space channels and for the exit of the exhaust gases through a similar discharge gas manifold. The discharge gas manifold is rotated by 180° relative to the vertical axis and is connected in a gas-tight manner to the ceramic part at the periphery. The flat surfaces of the gas manifolds furnished with holes are connected to the electrodes. They are simultaneously used as current collectors and the tubes are used as current terminals of the planar cell.

### CROSS-REFERENCE TO RELATED APPLICATION

This application claims the benefit of the priority filing date in PCT/IB2012/002774 filed on Dec. 20, 2012, and referenced in WIPO Publication No. WO/2013/093607. The earliest priority date claimed is Dec. 22, 2011.

### FEDERALLY SPONSORED RESEARCH

None

### SEQUENCE LISTING OR PROGRAM

None

### BACKGROUND

1. Field of the Invention

The invention relates to high-temperature electrochemical devices (ECD) based on solid electrolytes, for example, to electrochemical generators (fuel cells), electrolyzers, converters, pumps and other devices. Specifically, the invention relates to a planar cell design of such devices, to the design of any ECD battery with gas manifolds for at least one reagents, e.g. fuel, and to a manufacturing method for the planar cell and battery (stack) of such design.

2. Background Information

More sophisticated ECDs are known, namely, solid oxide fuel cells (SOFC) for direct conversion of fuel chemical energy into electric power. Such electrochemical conversion has a higher electrical performance (output-input ratio) than conventional power generation, for example, at heat power stations. In addition, electrochemical conversion is more environmentally friendly, because it reduces greenhouse gas emissions. A single solid oxide fuel cell possesses three basic and mandatory components: solid electrolyte, anode and cathode, as well as the so-called interconnect. A solid electrolyte is most frequently provided based on zirconium dioxide which conducts oxygen ions. Anodes and cathodes are electron-conducting. The interconnect typically consists of flat plates and is designed for cells connection to the battery. The conventional SOFC fuel is synthethic gas which can be produced from any fossil or synthesized hydrocarbons, biogases, waste products, and mainly comprises hydrogen and carbon monoxide. Using synthetic gas as the fuel fed to an anode, and oxygen gas from ambient air as the oxidant fed to the cathode, the following reactions occur

at the anode: 2H₂+2O²⁻=2H₂O+4e⁻ and 2CO+2O²⁻=2CO₂+4e⁻;

at the cathode: O₂+4e⁻=2O²⁻;

for the cell as a whole: 2H₂+O₂=2H₂O+heat and 2CO+2O₂=2CO₂+heat.

A conventional SOFC utilizes yttria stabilized zirconia (YSZ) ceramic as an electrolyte. The anode is a Ni—YSZ-cermet. Lanthanum-strontium manganate (LSM) is used for cathode material. A single cell voltage is around one volt. To increase the voltage, the cells are assembled into a battery using a series of electrical connections. To connect the cells to the battery by current so that the current paths (interconnects) with electronic conductivity, the following electrical connections are used: ceramic ones, for example, made of strontium lanthanum chromite, or metal ones, for example, made of high-chrome steel, type Crofer 22 APU.

Since all the components are in a solid state, SOFCs may be constructed in a variety of geometries.

Known are analogue cells which are used in electrochemical devices, for example, high-temperature fuel cells with supporting solid oxide electrolytes based on zirconium dioxide, having planar, tubular or module designs of solid electrolyte, both with an applied gas-diffusion anode and cathode, and with a supporting cathode, anode and current manifold. The module design combines the positive properties of tubular and planar designs. They appeared for the first time in the USSR in late 50s of the last century (USSR Author's Certificate of No. 121169, priority of Nov. 18, 1957).

A known analogue of single cells and batteries is described in detail in the following monographs (High-temperature gas electrolysis by M. V. Perfilyev, A. K. Demin, B. L. Kuzin, A. S. Lipilin, ISBN 5-02-001399-4, Moscow: Science, 1988, 232 p.; Science and Technology of Ceramic Fuel Cells by N. Q. Minh, T. Takahashi, Elsevier, 1995, 366 p.). FIG. 9.27, p. 268, chapter 9 of the latter describes a single cell design which may be provided both as a flat sheet and as a corrugated plate. The first design utilizes a corrugated current path, while the second utilizes a flat plate-like current path. According to the authors, an integral part of the cell and battery design should be the reagent's feeder and distribution assemblies fed to the cell and battery, as well as retractor assemblies for resultant products (gas supply channels) and current leads. Without them, the cells, batteries and ECDs would not function. In addition, it is impossible to estimate specific characteristics without them, for example, kW/l; kW/kg required for design comparison and determination of their application.

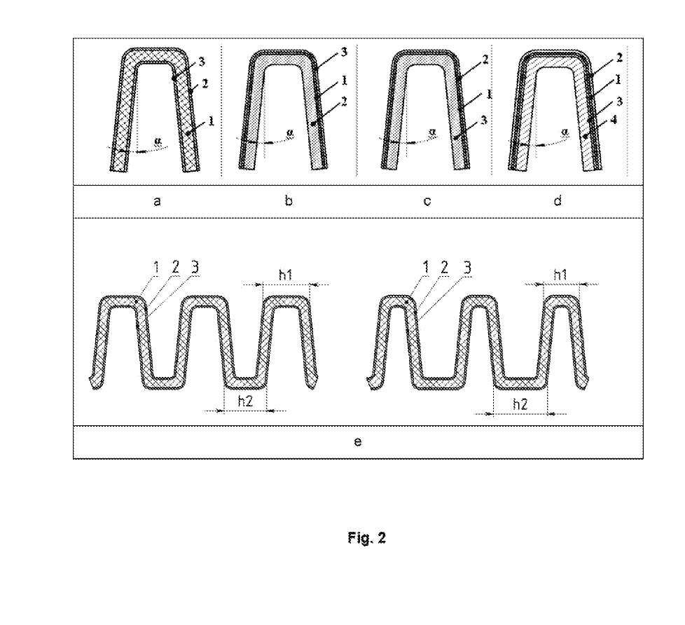

A method of tubular electrolyte manufacture is known (see DE 10 2010 001 988 A1), under which the electrolyte mass is injected into the space between the cast core and the mold. This method is designed for tubular SOFC formation, namely, for half-cells (i.e. thin layer cells and current manifold) that interconnect on a thicker solid supporting electrolyte. According to FIG. 2, because the electrolyte mass (10a) fills the metal mold space (12)—assuming that this space is formed with a metal core (13) and die casting split mold (11a, 11b) along the cell being formed—the electrolyte thickness cannot be less than 100 μm. The mold is opened by separation of the two parts, while the core is removed by dissolving the foundation. Certain parameters for electrolyte mass injection, as well as solid electrolyte thickness, are not specified in the source.

Document WO 00/69008 A1 describes a fuel cell with a half-cell multilayer design comprising a solid electrolyte layer with a preferred thickness from 15 to 25 μm and supporting electrode, for example, Ni/YSZ anode, with a preferred thickness not less than 500 μm; the best thickness being 300 μm, not manufactured separately. In addition, one more manganese oxide-based layer should be formed between them, in particular, with a preferred metal content from 0.1 to 5% (atom.). This intermediate layer is required to avoid martensite phase transformations of ZrO₂-based tetragonal solid electrolytes (containing less than 5% (mol.) of Y₂O₃) into the monoclinic structure during structure formation (with heating and cooling up to 1400° C.). This is because such transformations are accompanied by space variations and disruptions. To form the half-cell design, thin-layer films are produced through tape casting, and the intermediate layer (manganese oxide-based) is formed by means of air diffusion or another cost-effective controlled method. The source reveals no information about injection into the casting mold and reveals no subsequent supporting structure deformation. In addition, none of the specific stages of the method and process flow patterns are indicated. In this context, these structures can be examined only through a microscope, and one can only guess their impact on SOFC electrochemical properties, provided that these structures are generally reproducible during fuel cell manufacture.

Document WO 2009/014775 A2 discloses a fuel cell with a metallic supporting layer produced by a sprinkling method of films manufacture, die casting or similar method from a metallic powder mixture, bonding agent and pore agent. After the pore agent is vaporized, the metallic powder is sintered to produce a solid layer. This patent protects a multilayer architecture (claims 1-27 of the patent) containing numerous components and materials used in SOFC. The patent also protects a production method of such structures (claims 28-61 of the patent). However, this structure can be examined only under a microscope. Hot spraying of slurry into the casting mold is not disclosed.

The closest analogous solution and prototype of the invention is the structure under US patent 2009/0042076 A1 published on Feb. 12, 2009, Modified Planar Cell (MPC) and Stack based on MPC (Modified Planar Cell (MPC) and Stack based on MPC), Filed on Aug. 8, 2007 U.S. Patent and Trademark Office Ser. No. 11/889,062).

This patent describes a single SOFC cell of corrugated architecture, and a battery consisting of such single cells. However, this patent mentions only one possible manufacturing technique for YSZ electrolyte ceramic blanks for the cell, according to the described method with subsequent electrode application by means of a coating.

During ECD manufacture, particularly that of SOFC, a thin ceramic layer based on yttrium stabilized zirconium (YSZ) or scandium stabilized zirconium (ScSZ), and nonconventional solid electrolytes based on cerium oxide or on lanthanum gallate, are most frequently used as a solid electrolyte. The main advantage of the planar design, compared to a tubular one, is the high packing density of cells inside the battery (high ratio of operating surface to the volume (S/V−(cm²/cm³) or 1/cm). One of the electrochemical cell components (cathode, solid electrolyte, anode) is accountable for the mechanical strength of the cell. In this case, cells of one and the same structure may be provided with a supporting electrolyte when a solid electrolyte of a thickness larger than the operating (required) electrolyte is accountable for mechanical strength. Meanwhile, the solid electrolyte has a supporting anode (most frequently made from nickel-cermet—Ni+YSZ) or cathode (from strontium lanthanum manganite—LSM), having a larger thickness accordingly.

The most efficient and economically sound electrochemical devices for stationary use is one that transfers the mechanical strength function to a current manifold composed of porous cermet. For cell connection to a battery (ECD), either a ceramic or a steel current path is frequently used, which have coatings from materials of the same electrodes at the contact surfaces facing opposite electrodes.

The most popular methods for flat and tubular cell formation are: plaster mold slip casting (from the powder material water slurry), thin films casting from slips based on butyraldehide resin (Tape Casting (analogue)) and cell hot casting from slips based on paraffin (hot paraffin slurry of the powder material) into a cold steel mold (prototype). In the last case, the cell structure ceramic blank formed from a powder, for example, YSZ, uses a ceramic injection cast method (CIM) into the metal mold, and then is sintered until compact (http://www.solidcell.com).

Disadvantages of the planar structure analogues and prototypes may be a complexity of the sealed connection of gas manifolds at the input and output of reagents in the cell and battery, and rather long sealed connection seams compared to the operating area (1/S-cm/cm² or 1/cm). Since the sealed connection of dissimilar materials is required for such structures, it not only makes the manufacture of cells more complicated, but also decreases the overall reliability of ECD and reduces its operating life.

Disadvantages of this method include the inability to manufacture cells with a minimum reproducible internal value (reproducible cell wall thickness and with the wall thickness of less than 0.4-0.5 mm). Basically, the prototype method on the equipment known and used in electronic industry allows for production of items with walls thinner than 0.1-0.2 mm (cast ceramic capacitors). However, their geometry and dimensions in mm units do not meet the requirements for high-temperature electrochemical cells with a minimum operating area of 75-100 cm².

### SUMMARY OF THE INVENTION

The technical task of the invention is to eliminate the above-mentioned disadvantages of cells and batteries, and the manufacturing method of the suggested cell design and mold.

The modified planar cell design and battery with gas manifolds is intended to combine key advantages of planar and tubular structures, while having a higher packing density compared to the planar structure, as well as a structural gas-tight separation of anode and cathode gas spaces compared to the tubular structure.

The task set is solved by means of the characteristics of the independent patent claims.

According to the first aspect, the invention represents a modified planar cell with (at least) one solid electrolyte, (at least) one anode and (at least) one cathode, where the solid electrolyte, anode and cathode form a corrugated plate composed of corrugations which form channels in the form of isosceles trapezoids of equal height, or without a greater lower basis for one reagent, and channels in the form of inverted isosceles trapezoids without a greater upper basis for another reagent.

The words upper, lower, vertical, etc. are used in this application only to describe corresponding objects through certain spatial arrangements, for example, presented in the drawings. Under such conventional arrangements, the plane of the above-mentioned plate is usually located horizontally. According to the overall invention, this does not specify any strict boundaries and does not exclude any certain spatial arrangement of objects. Reference to vertical position, etc. relate to the overall plane described by the above-mentioned plate.

With trapezoidal channels for reagents, the manufacturing process the above-described planar cell can be simplified. This, in turn, results in improved functional properties as a result of more uniform layer thickness of the components involved, and in mechanical strength enhancement.

According to the invention, the angle between lateral sides of the trapezoid channels and the corresponding basis of the planar cells is usually within the range of app. 0.1° to app. 89.9°. In particular, this angle may be more than app. 0.5°, more than app. 1.0°, more than app. 2.0° or more than app. 5.0°.

The corrugated plate edges are preferably provided as rounded edges to avoid sharp bending angles with corresponding loads on the material.

The solid electrolyte may specifically represent or contain solid oxide.

In addition, the modified planar cell preferentially contains a current path for the planar cell components connection, ensuring electrical conductivity. In this case, the current path may be made of metal or oxide.

In addition, the modified planar cell also preferentially contains a metallic box-like gas supply duct for the required reaction gas supply, reaction products removal or generated current collection. The metallic box-like gas supply duct is preferentially electron-conducting.

To achieve adequate stability, the corrugated plate of the planar cell is generally provided as the supporting plate. In this respect, a permissible load can be achieved though joint use of several components (solid electrolyte, anode, cathode and/or current path). At least one of these components is preferentially provided as independently supporting (i.e. supplied with layer of sufficiently high thickness), while other components are preferably not supported by themselves.

The corrugated plate channels are closed preferably with lateral walls and/or surfaces from the top and/or from the bottom. In this case, to supply or remove reagents, the lateral walls, top and bottom surfaces, and/or at the bases of trapezoid channel may have apertures which coincide with the corresponding apertures of gas manifolds or other modified planar cells (within the planar cells battery). The lateral walls, top and bottom surfaces, are preferably parts of other components, for example, gas manifolds or current paths.

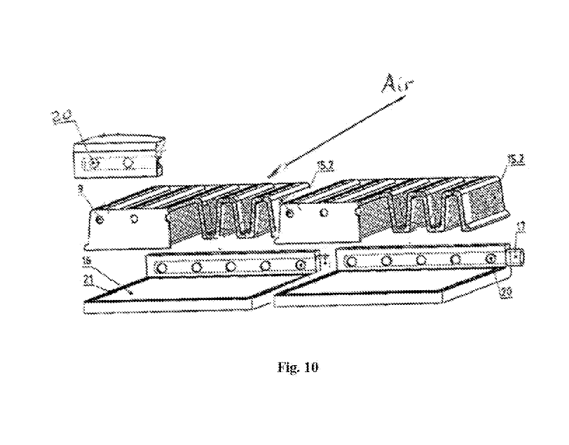

According to another embodiment of the invention, the modified planar cell channels can also be open upward or downward at the greater trapezoid base to allow for direct contact with reaction gas (for example, air) (see FIGS. 10, 11).

During operation, the fuel passes through the planar cell channels. To feed fuel or remove its residues, either input gas manifold and/or output gas manifold can be provided. In this respect, the output gas manifold is preferentially rotated by 180° against the input gas manifold axis. This means that the output gas manifold collects gases from one end of the channels opposite the end at which the input gas manifold lets the fuel gas into the channels. Except for its turned or mirrored arrangement, the input and output gas manifolds should be preferably of equal structure.

The channels within the corrugated plate of the planar cell should generally be closed from their upper or lower side. This can be achieved, for example, by means of a flat surface of the gas manifold located at and/or below the channels. In addition, such flat surface of the gas manifold should preferably be connected to the plate electrodes so as to act simultaneously both as the current manifold and as the current clamp of the planar cell.

As a rule, the anode and/or cathode of the modified planar cell are gas-diffusion.

The Anode and cathode of the modified planar cell are usually arranged on different sides and/or different surfaces of the corrugated plate, so that the solid electrolyte is placed between them, and in conjunction, they constitute an electrochemical cell.

The corrugated plate of the modified planar cell may have exactly one anode and/or exactly one cathode.

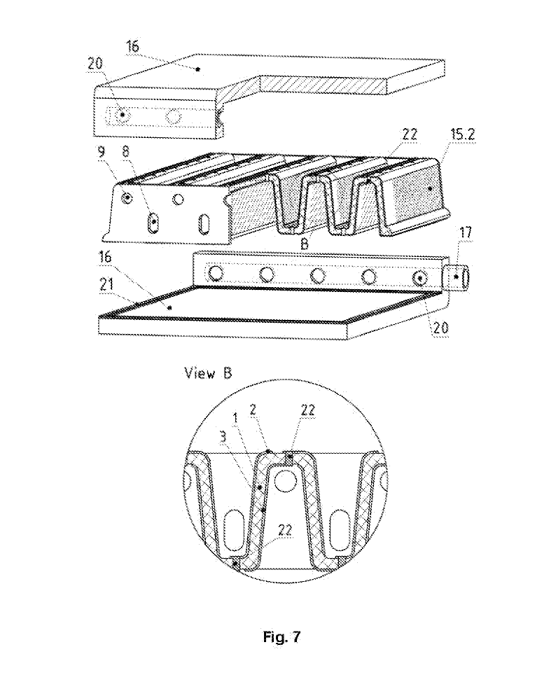

However, certain embodiments of the planar cell involve several pairs of opposite electrodes (i.e. anodes and cathodes), so that in each pair they are arranged along at least one channel of the corrugated plate (anode and cathode on different surfaces of the channel wall). In this case, owing to an appropriate series of cell electrical connections formed in this way, higher voltages may occur in the planar structure. The electrodes are preferably arranged with a shift towards different sides of the solid electrolyte so that they could be connected by means of the interconnect (FIG. 7, pos. 22) through a solid electrolyte.

The preferred embodiment involves at least two cathodes and at least two anodes representing electrochemical cells electrically interconnected in series. In this respect, they are connected through the current path (interconnect) either point-wise, or anode, is connected with cathode of subsequent cell along the whole width/length.

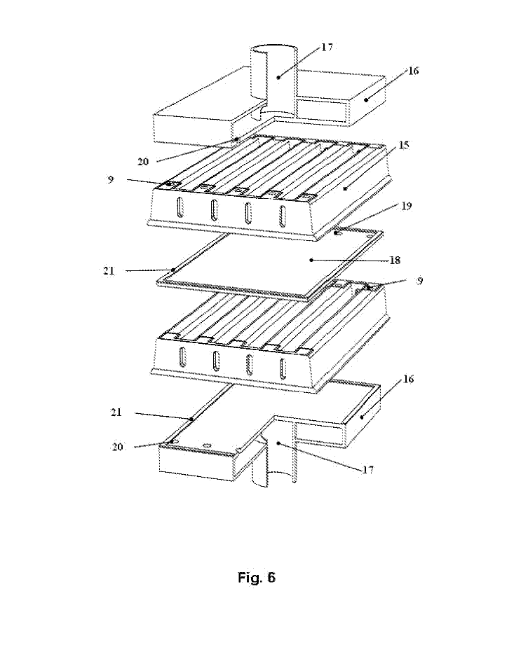

As an option, several modified planar cells can be integrated into the battery. In this case, the assembly can be conducted in any direction, in particular in transverse direction (with increase of number of channels, see FIG. 10), longitudinal direction (with extension of channels, see FIG. 11) and/or in elevation (perpendicular to the corrugated plate plane, see FIG. 6). In these cases, it is necessary to provide appropriate alignment of the gas manifold and current paths.

The invention offers a new architecture of the single solid-oxide cell, ing the basic principle of SOFC planar design, namely the battery parts sequence: anode, electrolyte, cathode as well as the current path, thereby presenting a new modification of the cell composition. Consequently, this structure represents a modified planar solid-oxide fuel cell. At the same time, mechanical and electrical properties of the cell are improved, because the rectangular structure of gas channels with mechanical stresses concentrated at the corners, and with the thinning of electrodes at the rectangular ridge, have been replaced. This thinning leads to an increase in the cell and battery's internal resistance. In this case, a large number of solid electrolyte walls also leads to enhancement of packing density and improvement of specific cell characteristics. To align the inter-space pressure and flow speed of fuel and air in SOFC, for example, the air channel in this section should be twice as large. The apertures, in cross-section, for reagent input and product reaction output differ in the same way.

In this case, the suggested structure ensures uniform gas flow distribution both between the cells and along the electrode surface of each cell.

The authors also offer the formation method of the structure stated. The suggested structure consists of at least one three-layer film (anode-electrolyte-cathode) for the corrugated electrochemical part of the cell and for its connection to the front and rear wall, and for perforated flat front and rear walls through which one or both reagents are fed. This film is made from electrolyte film or from structural material. At the same time the gas manifold can be arranged either from an upper and lower side of the cell (in case the cells are connected to the battery along their vertical axis) or from its front and rear walls for one or both reagents. Such embodiment of the cell allows not only for parallel feed of the oxidant, but also, unlike the prototype, for parallel feed of the fuel into the battery. This enhances the reagent feed's uniformity and that of the inter-space pressure. As a result, from now on, there is no need to restrict the number of cells within the battery. In this case, the formation method of a thin-film cell with functional thickness made from the layers selected by the authors also results in a decrease of internal cell resistance, an increase of their packing density, and enhanced specific characteristics of the cell and its energy performance.

Another embodiment of the battery implies a solid electrolyte having a multichannel cell structure. The opposite electrodes of the single cells are applied to every wall of the channel or channel group, and are electrically connected in series. Such engineering solution allows
for production of higher voltage batteries that generate lesser electrical currents, material consumption being the same,
for the batteries connection into stacks along the horizontal axis without the need for conventional flat interconnects,
for area extension of the single cell due to an increase in channel length. Consequently, electrical performance is maintained.

Such battery embodiment also allows additional buildup of generated voltage, increasing the number of cells arranged on (more than one) channel wall.

The authors suggest a formation method for the structure stated through hot steel mold casting. In this respect, higher speeds for slip casting are used. The used mold ensures manufacture of modified planar cells with movable trapezoidal plates within the filling zone.

Another embodiment of the formation method for thin-film ECD with functional values of thickness of all the components is the Tape Casting technique.

It should be pointed out that all the features of the embodiments mentioned in the patent claims or in the examples embodiments in conjunction with other features have independent meaning, and therefore may become subject of a patent claim, irrespective of any other features along with which they are mentioned.

### DETAILED DESCRIPTION OF THE EXAMPLE EMBODIMENTS

The invention is described in greater detail using the embodiments shown in the drawings, namely:

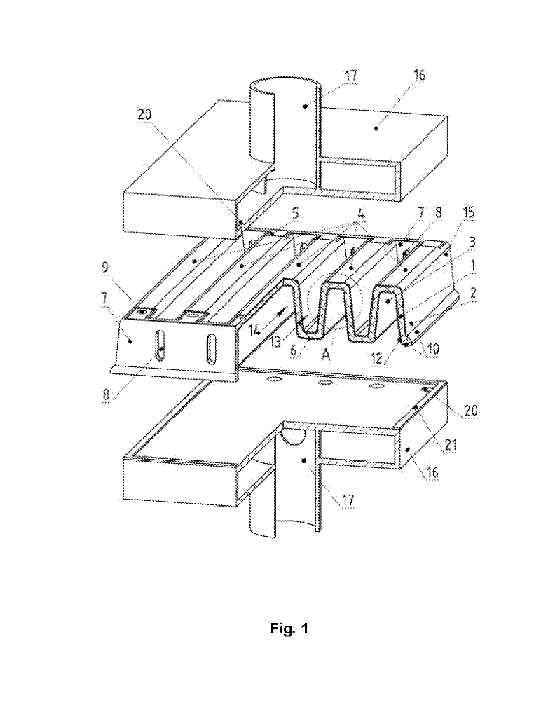

The modified planar cell is illustrated in FIG. 1 (first embodiment). The modified planar cell contains supporting solid electrolyte 1 and electrodes, cathode 2 and anode 3. The working part of the planar cell is provided as corrugated plate 4, having at least three layers. Three-layer plate 4 consists of the odd number of [symbol] -shaped corrugations 5 of equal height. Corrugations 5 are interconnected at the bottom with flat connectors 6 that form [symbol] -shaped gas spaces/channels between corrugations 5. Each [symbol] -shaped corrugation 5 in cross-section is an isosceles trapezoid without lower base, and is connected to adjacent [symbol] -shaped corrugations 5 with flat connectors 6. Meanwhile, [symbol] -shaped gas spaces occur in the form of inverted isosceles trapezoids without a greater base and opened above in cross-section.

To form gas channels of the uniform gas supply system and generated current collection, for example, during ECD operation in the fuel cell mode, the active electrochemical part of the cell is connected with input and output (outlet) gas manifolds 16, and correspondingly, with the metallic box-like gas supply ducts 17 for fuel supply and reaction products removal. If the metallic box-like gas supply ducts 17 are made from metal, they serve as current collectors (clamps) of the planar cell at the same time. The metallic box-like gas supply duct 17 are arranged in box-like gas manifolds 16 and have an aperture for uniform distribution of reagent gas flows within the planar cell along apertures 9. The metallic box-like gas supply ducts 17 are connected mechanically and electrically to the gas distribution plate with apertures 20 and gas manifold box, and therefore ensure efficient current collection using a generating power battery from the external part of the metallic box-like gas supply duct 17.

FIG. 2 shows sections [symbol] ( [symbol] ) in the form of ceramic sections of a corrugated plate 4 at the corner rounding-off points between lateral sides of trapezoids and lesser bases. Rounding-offs are required so as to exclude the points of mechanical stress concentration that leads to disruption, and to achieve equal thickness of electrodes being coated within these points. FIG. 2 shows sections A (FIG. 1) of a single [symbol] -shaped channel of the planar cell electrochemical zone with different embodiments (claims 6-9 of the patent), namely:

a—supporting solid electrolyte; b—supporting cathode; c—supporting anode; d—for example, supporting anode current manifold (In which case numbers 1, 2 and 3 refer to solid electrolyte, cathode and anode respectively, whereas number 4 refers to anode current manifold). A similar structure is possible with a supporting cathode current manifold. When forming an electrochemical part of a thin-film cell with functional values of thickness, the planar cell is exposed to mechanical stress because of the inter-space pressure drop (what is meant here is pressure within anode and cathode spaces). In this case, a pressure drop is caused by various reagent gas flows passing.

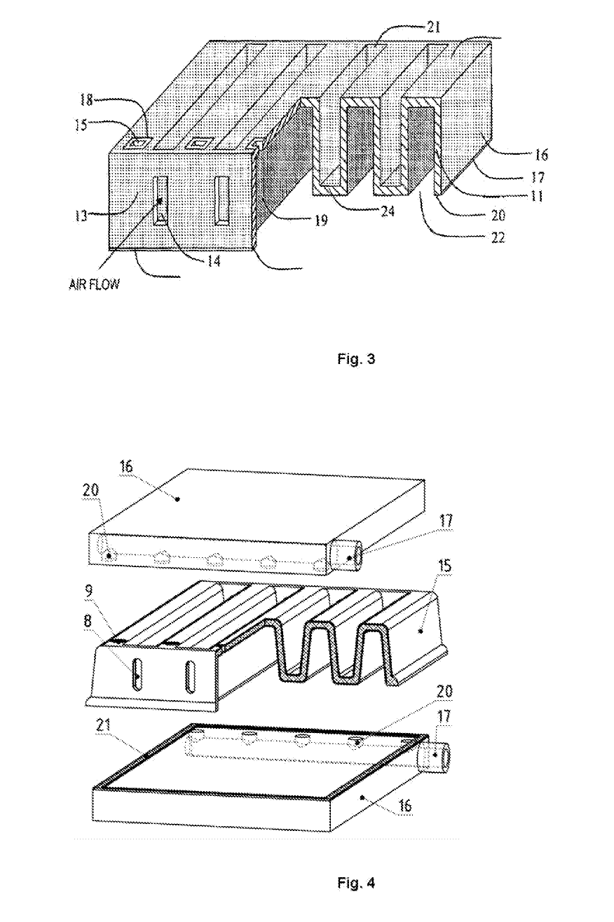

To align the inter-space pressure drop, the width values of gas channels h1 and h2 are made proportional to reagent gas flows (FIG. 2d). Angle α between the lateral side and the lesser base of the trapezoid may vary from 0.1 to 89.9°. In case the angle is less than 0.1° (pattern draft), it is physically impossible to manufacture the part of this structure (see FIG. 3—prototype).

At the same time, the angle may increase up to 89.9. When α is equal to 90, the cell with [symbol] -shaped corrugations 5 is transformed into the flat plate 4 of the planar cell. The front and rear part of the planar cell, from the corrugated plate 4, are restricted with flat lateral walls 7 made from solid electrolyte or structural ceramic. Each of the lateral walls 7 has apertures 8 leading to spaces [symbol] between [symbol] -shaped corrugations 5 in SOFC. They are intended for air supply and hypoxic mixture removal. At the top of each [symbol] -shaped corrugation 5, there is an aperture 9 for fuel supply that leads into an internal space of [symbol] -shaped corrugation 5. A solid electrolyte 1 which communicates with the modified planar cell surface is coated with a layer of porous cathode 2. Only the area 10 on the lateral and bottom surfaces along the lower perimeter of the planar cell and zones 11 at the ends of [symbol] -shaped corrugation 5, including those around the upper apertures 9, remain uncoated. Communicating with the lower surface of the modified planar cell, the solid electrolyte 1 is coated with a layer made out of the porous anode 3, exclusive of the strip 12 at the bottom of the electrolyte along the lower internal perimeter.

The apertures 8 in the front part of the planar cell are intended for air supply, while the apertures 8 in the rear part of the planar cell are intended for exhaust air removal. The exhaust air is hypoxic mixture O₂+N₂ (with decreased oxygen content). Each air channel 13 is formed by [symbol] -shaped space between [symbol] -shaped corrugations 5 and current path, or by a flat electrically insulating plate that limits cathode space. The current path adjoins the top of the planar cell. Apertures 9 are intended for fuel supply. Each fuel channel 14 is formed by an internal space of [symbol] -shaped corrugation 5 and a current path, or by a flat electrically insulating plate that limits the anode space. The current path adjoins the bottom of the planar cell.

The fifth embodiment (claim 10 of the patent) of the planar cell is shown in FIG. 4.

In this case, the modified planar cell with electrochemical part 15, for example, with supporting solid electrolyte and electrodes, cathode and anode, contains a gas and current manifold for improved electric current distribution over the active part of the planar cell with an increased area. The gas and current manifold is provided in the form of a plane electron conducting plate 16, the length and width of which correspond to the length and width of an electrochemical planar cell with the metallic box-like gas supply duct 17. The plate 16 has a common aperture for fuel supply and apertures 20. The common aperture is located along one side of the plate (at the front or at the rear). The apertures 20 penetrate the surface for connection with an active part of the planar cell and for the flow distribution through input apertures 9 of every [symbol] -shaped channel of the SOFC. The apertures 20 and 9 are gas-tightly interconnected, forming an anode space of the planar cell with an electrochemical part 15 and output gas, and current manifold gas-tightly connected, for example, using a glass sealant 21, along the perimeter. The fuel comes through the input gas and current manifold 16, distributing evenly through apertures 20, and entering the electrochemical part of the planar cell. After passing through [symbol] -shaped channels, the reaction products (fuel residues) come outward through apertures 20 of the lower gas and current manifold. the metallic box-like gas supply duct 17 are intended for fuel supply into the common aperture of gas and current manifold, and for reagent removal, and can both reach the lateral surfaces of the planar cell, and front and rear surfaces.

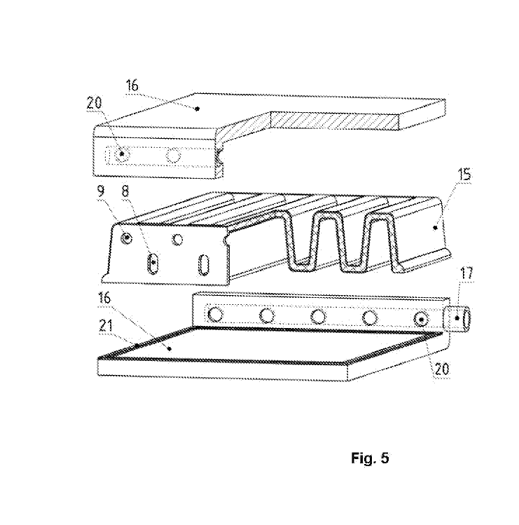

The sixth embodiment of the planar cell is shown in FIG. 5.

In this case, the modified planar cell with electrochemical part 15, for example, with supporting solid electrolyte 1 and electrodes, cathode 2 and anode 3, has two rows of apertures: one row, for example, the upper one, includes apertures 9 in the front and rear walls 7 made from solid electrolyte or structural ceramic for fuel supply into [symbol] -shaped channels. The other row, for example, the lower one, contains apertures 8 with a larger section for air supply into [symbol] -shaped SOFC channels and for hypoxic mixture removal from the planar cell. The lower and upper rows of apertures are located on the front lateral wall. If the battery is manufactured from a series set of cells along the vertical axis, it is reasonable to use the structure of the planar cell electrochemical part as end cells. The upper gas and current manifold 16 is manufactured from electron conducting material, for example, high-chromium steel, e.g. Crofer 22 APU. It is connected with the planar cell (cathode) and ensures fuel feed. The lower gas and current manifold 16 is similar to the upper one, connected with the anode of the cell and, for example, ensures the removal of fuel residues. According to all previous embodiments, the cells have [symbol] -shaped fuel channels of the section lesser than that of [symbol] -shaped air channels of the SOFC. Their cross section is proportional to gas flows.

For a series electrical connection of the planar cells, as well as for higher voltage generation, the planar cells (variants) can be assembled into the battery (the first variant) along the vertical axis. In this case, each subsequent cell is rotated by 180, FIG. 6 (as an example the figure shows the first embodiment of the planar cell).

The battery consists of several cells 15 (as an example only two cells are shown) and has input and output gas manifolds 16 with the metallic box-like gas supply ducts 17 for fuel supply and reaction products removal correspondingly. The metallic box-like gas supply ducts 17 simultaneously serve as current collectors (clamps) of the battery. The metallic box-like gas supply ducts 17 inside box-like gas manifolds 16 have an aperture for uniform distribution of reagent gas flows in the planar cell by apertures 9. These metallic box-like gas supply ducts 17 are connected mechanically and electrically with a gas distributing plate with apertures 20 and gas manifold box 16, thus ensuring effective current collection of generating power battery with external part of the metallic box-like gas supply duct 17. The gas manifold boxes 16 are attached to the planar cells. The cells are interconnected with the plate 18 of the current path. The current path represents the flat plate 18, the length and width of which coincide with the length and width of the very planar cell. The plate 18 near the apertures 19 is connected with the top of the planar cell so that its apertures 19 coincide with corresponding apertures 9 in the upper row of [symbol] -shaped corrugations 5 of the planar cell. The apertures 20 for fuel supply and reaction products removal also geometrically coincide with the apertures 9 of the planar cells.

A sealed connection of the planar cells, current paths and gas manifolds in the battery, is achieved through a connection with the glass sealant along the perimeters of the apertures 9, 19, 20 at the connection points between the upper ceramic edge of the planar cell and the lower edge of the upper plate 18 of the current path, as well as between the upper ceramic edge of the upper planar cell and input manifold 16 within the areas around the upper apertures 9. These connections create a gas-tight seal between the planar cell and the bottom of the plate 18 of the current path, or between the planar cell and the bottom of the input manifold 16. To achieve an adequate strength at the connection points between the upper ceramic edge of the planar cell with corrugated plate 4 against the face of the apertures and the lower edge of upper plate 18 of the current path, as well as between the upper ceramic edge of the upper planar cell against the face of the apertures and input manifold 16, a connection is also made with the glass sealant. These connections may leak. Gas-tight connections using a glass sealant 21 are made along the perimeter of the lower edge of the first planar cell, and the upper edge of the plate of the current path 18 peripherally and between the lower edge of the second planar cell (or end cell in the battery) and output manifold 16. Such connections create a gas-tight seal between the first planar cell and the bottom plate 18 of the current path, as well as between the second planar cell and output manifold 16. The fuel comes into the metallic box-like gas supply duct 17—current collector of input manifold 16—and then flows through a number of apertures 20 from the lower side of the input manifold 16 and a number of apertures 9 from the upper side of the planar cell into anode channels of the planar cell. The flow moves along the channel, and at the end of the channel, flows through a number of apertures 19 in the current path plate 18, and through a number of apertures 9 from the upper side of the second planar cell to the next planar cell. To ensure a continuous fuel flow through the fuel channel from the upper planar cell to the adjacent lower planar cell, the coupling planar cells are rotated by 180° to each other along their vertical axis. The exhaust anode gas comes out of the last planar cell of the battery through a number of apertures 20 from the upper side of exhaust manifold 16 and through the metallic box-like gas supply duct 17 as a current collector of the output manifold 16. Air-flow comes into apertures 8 in the front wall of the planar cell and comes out of similar apertures 8 on the opposite side of the planar cell. FIG. 6 shows sections of gas and current manifolds 16. Each manifold consists of a metallic box-like gas supply duct—current collector 17—and rectangular box of the same length and width as the planar cell. The metallic box-like gas supply duct 17 is built in one wall of the box, thus forming a gas flow towards the opposite wall of the box. The opposite wall of the body has apertures 20 which are aligned with a row of apertures in the upper side of the planar cell. The upper gas manifold 16 is intended for fuel injection into the battery, while the lower one is for exhaust anode gas removal from the battery. The manifold is manufactured from material compatible with materials of the solid electrolyte and current path.

FIG. 7 shows the second embodiment of the battery.

Structurally, the electrochemical and ceramic part, the fuel distribution, the fuel and oxidant supply assemblies, and the reagent removal assemblies are provided in a manner similar to those of the single cell. However, the corrugated plate 4 from the solid electrolyte (see prototype, FIG. 3 and FIG. 1, 4, 5) has several pairs of electrodes rather than two electrodes, one as a cathode at the top and a second as an anode at the bottom. Thus, one ceramic blank may represent one SOFC comprising five [symbol] -shaped fuel channels and four [symbol] -shaped air channels, or such ceramic blank may represent a battery of two cells, if the anode of the left cell (2.5 of [symbol] -shaped channels) is electrically connected with the cathode of the right cell (2.5 of [symbol] -shaped channels) and the third [symbol] -shaped fuel channel. The battery is formed of five cells, if each [symbol] -shaped fuel channel is a cell, and their series electrical connection is an anode of the previous cell with a cathode of the subsequent cell—provided at the bottom of every [symbol] -shaped air channel. If every wall of the channels represents an electrochemical cell, a series electrical connection of which is made both at the bottom of each [symbol] -shaped air channel and at the top of every [symbol] -shaped fuel channel (see FIG. 7), a 10-cell battery would be formed. If every wall has two, three or more connected cells, a battery of the corresponding number of planar cells would be formed. This, without prejudice to electrical performance, allows for an increase in battery dimensions in height, width (number of channels) and length, and for capacity enhancement by increasing the voltage and decreasing the current. This reduces ohmic losses, material consumption and weight characteristics. Electrical connection of such batteries is carried out either horizontally widthwise (increasing the number of channels) or as usual—vertically, as in the first embodiment and in FIG. 6. In this respect, the current path (interconnect) material is replaced by electric insulating (structural) material, e.g. from oxide ceramic based on Al₂O₃ or Al₂MgO₄ (alumomagnesian) spinel. Therefore, the plate 18, which connected the cells by current, loses its function and serves as a separating plate which mechanically connects the modular batteries, separating and forming gas flows. Similarly, the gas and current manifold loses the current manifold function (electronic conductivity) and performs only the gas manifold function. That is why it is manufactured from electric insulating material.

According to the authors, one of the reasonable formation methods for the modified planar cell supporting component (first embodiment) is a hot slip casting method, for example, based on paraffin, into a cold steel mold (ceramic injection molding—CIM). Hot slip casting occurs at a temperature that provides its fluidity. In this case, the critical factor for formation of a solid electrolyte layer with sufficient mechanical strength (100-150 μm) is the cast time under casting of the required amount of slip: the slip should not be frozen (hardened) during its passing trough thin clearance between the cold steel plates, but should remain liquid so that it flows inside the narrow channels and merge to form the cell. In this case, the flow laminarity conditions should be observed. To achieve a more homogeneous (in terms of density) cast, the filling process is conducted at full speed. This can be achieved by an increase of the pressure and temperature of the slip being cast.

As claimed in 6, to manufacture the modified planar cell with a 150 μm-thick supporting solid electrolyte, the injection time for the required portion of slip containing YSZ powder should be less than 0.2 sec because the hot slip flow should pass through the narrow channels of the mold and merge, forming the corrugated plate 4 of the planar cell. In this respect, the flows should neither capture the air nor create turbulence, as at these casting points (cell blanks), porosity and reduced density occurs. This is of particular importance for casting of that solid electrolyte which, within the cell structure, should be dense and without open-through porosity. To achieve greater density of the cast blank, the plasticizer part in the slip is usually decreased. This is achieved by injecting autol, halowax and resin. After being retrieved from the mold, the blank may undergo mechanical treatment to form its final shape (formation of apertures, channels, rounding-off of sharp edges of ceramic channels, etc.). Retrievability is achieved by the mold taper, namely, owing to an angle α between the lateral side and lesser base of the trapezoid of the corrugated plate 4 for the claimed planar cell (see FIG. 1). Once the cast is retrieved, paraffin is usually vaporized, followed by high-temperature burning in the process of which the blank is sintered, i.e. its density is increased, while its porosity is decreased. This process is accompanied by a reduction of the blank geometrical dimensions (shrinkage).

During casting of the modified planar cell blanks with the supporting cathode, anode or current manifold, and during formation of the layer of SOFC supporting component with thickness that ensures mechanical strength of 300-500 μm, the required amount of slip is injected into the mold within 0.2-1.0 sec, without violating laminarity requirements, to the flows being cast. In this case, the slip would contain the powder from the supporting component material. Since blanks have thicker walls and should remain porous after sintering, the requirements for casting are not so strict. In this respect, there is no need in carrying out the process for less then 0.2 sec with an increased pressure, and there is no use in conducting it for more than one second. Otherwise, the slip flows within the blank structure would not collapse.

Another reasonable method of the modified planar cell structure formation (second embodiment) is an industrial tape casting method. One side of the solid electrolyte film (ScSZ, YSZ) cast from a thermoplastic slip (for example, polyvinyl butyral-based), which is 40-100 μm thick, is coated with a functional cathode layer, while the other side is coated with a functional anode layer. The coating is through methods like recurrent watering (Tape Cast), silk screening (Screen Print), forge rolling or combinations thereof. According to FIGS. 1, 4 and 5, any coating method is suitable for planar cells. According to FIG. 7, silk-screening (Screen Print) and forge rolling are suitable for the batteries. In this case, opposite electrodes are applied with a shift that ensures a series electrical connection of the planar cells. The corrugated three-layer plate of the planar cell or the battery plate with electrodes (electrode width, for example, is equal to the height of [symbol] -shaped channel, FIG. 7) is shaped inside the special appliance. The plate is attached to the front and rear wall 7 (FIG. 1) from the electric insulating structural material film heated up to 90-110° C. with the pressure of 0.2-0.4 hPa, and apertures 8-9 for oxidant and fuel are formed. This is followed by joint-sintering (Co-Fire). After that, the blank is used for the battery assembly (connections of gas manifolds and electrical switching).

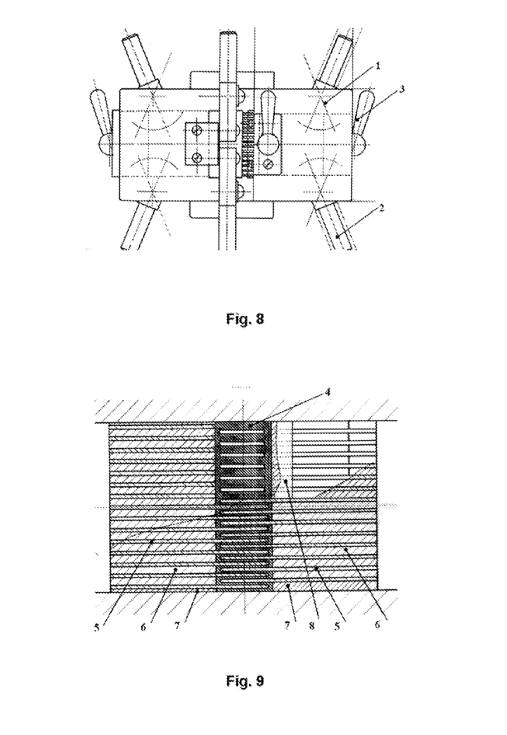

To carry out the first method—hot casting of the modified planar cell as claimed in 6—a steel mold is required (see FIG. 8) which ensures the production of the single cell blank (cast) structure.

The mold consists of a steel body 1 with mechanisms that enable movement of movable forming plates with respect to immovable plates using handles 2. Handles 3 with threaded coupling are provided for mold disassembly and cast retrieval.

FIG. 9 shows the mold, in cross-section, explaining the cast forming of a cell 4 with a modified planar cell structure. Movable plates 5 have plane-parallel and trapezoidal parts with angle α that ensures mold taper during formation of [symbol] -shaped and [symbol] -shaped gas spaces of the cell corrugated part (see pos. 4 of FIG. 1). The plane-parallel part of movable plates 5, moving in reference to immovable plates 6, is required after casting during cast retrieval. Immovable plates 7 ensure cast retention, when movable plates 5 are taken out-when the cast is retrieved out of the mold during its disassembly.

Thus, a group of these inventions ensures manufacture of modified planar cells with an optionally supporting solid electrolyte, for example, based on zirconium dioxide (YSZ, ScSZ), with an optionally supporting cathode, optionally supporting anode and optionally supportin) current manifold, that ensure not only an improvement of specific characteristics (W/sm², sm/sm², kW/l, kW/kg), but consumer-oriented properties of electrochemical devices, namely, better reliability and extended service life.

FIG. 10 shows two modified planar cells integrated into a battery in cross direction. The planar cells may contain, for example, several pairs of anodes and cathodes similar to FIG. 7. In each single planar cell, the channels on each side are closed with lateral walls, in which case, access to each channel with a greater lower base in the lateral wall is provided by aperture 9. The lower side of all the channels is closed with a gas manifold plate 16. The upper side of the channels with a greater upper base may optionally remain opened, providing a direct access for the air to these channels. In addition, the gas manifold channels are attached to lateral surfaces, in which case, apertures 20 of gas manifolds are connected with apertures 9 of the lateral walls. Electrically, both modified planar cells are connected by contacts on lateral walls 15.2 of the corrugated plate. To achieve a synchronous fuel supply into the corrugated plate channels, the gas manifolds for reagent feed and removal are interconnected.

FIG. 11 shows a battery variety according to FIG. 10, where two modified planar cells are longitudinally connected into a battery. To achieve the gradual fuel feed into the corrugated plate channels, the latter are interconnected by means of front and rear walls of the adjacent cells, in which case, a series, or parallel electrical connections, is effected by means of contacts through surfaces 15.2.

FIGS. 6, 10 and 11 show options of the planar cell battery formed in height, cross and longitudinal direction, which can be implemented for more than the two illustrated planar cells. In addition, these options can be combined at random to form a battery.

The described invention relates to a manufacturing method for a cell and battery assembly in the form of modified planar cells (FIGS. 1, 2, 4, 5, 6, 7) for high-temperature electrochemical devices, i.e. visible objects as large as several centimeters and up to several meters, the capacity of which varies from several watts to several megawatts, and also to a manufacturing method of this assembly from macro objects. The method for cells and batteries formation includes enumeration of technological stages and describes certain technological modes.

The above-described methods represent an optimized manufacturing technology. These methods allow for execution of new specified structures not only with supporting electrolyte, but also with a supporting anode, a cathode and a current manifold. At the same time, the thickness of the manufactured supporting solid electrolyte can be 100 μm and less. Due to this fact, according to the invention, specific capacity within the cell may reach 10.0 W/cm³, which is 25 times higher than that of the prototype under source US 2009/0042076 A1.

The invention offers structural versions and manufacturing methods for promising and high-performance high-voltage SOFC, namely, a modified planar cells. In addition, it discloses manufacturing methods for such structures using industrial techniques of film-casting and metal mold casting. Unlike in DE 10 2010 001 988 A1, this invention teaches the formation, not of a tubular electrolyte (half-cell) blank with closed butt end, but a SOFC blank of a new structure. All the disadvantages of the known structures are eliminated in this structure because it combines the advantages of tubular and planar versions. This structure allows for the manufacture of devices with a specific capacity of up to 20 kW/l.

In one embodiment, the electrochemical part of the cell (corrugated plate) is formed with one, two or more pairs of opposite electrodes applied with a shift so as to ensure a series electrical connection of the cells on an electrolyte film. The films are interconnected, which makes it possible for the electrodes of the adjacent cells to interconnect (series electrical connection of cells into the battery). After that, a corrugated plate with channels, in cross-section having the form of an isosceles trapezoid without a greater lower base, and with the channels, representing inverted isosceles trapezoids of equal height without a greater upper base, is formed inside the special appliance, in which case, an angle α at the lesser base preferably equals to 0.1-89.9°. Then, the corrugated plate is connected with two opposite walls, the front and rear ones, in which case these walls are arranged perpendicularly to the corrugations, have the same height, and are manufactured from a film of electric insulating structural material heated up to 90-110° C. and with a pressure of 0.2-0.4 hPa. Afterwards, apertures for reagent supply and removal with subsequent joint sintering (Co-Fire) at 900-1200° C. are formed.

This invention can be used in the manufacture of electrochemical items not only for SOFC, but also for other high-temperature electrochemical devices (ECD) with a solid electrolyte, for example, electrolyzers, converters, oxygen pumps, etc.

1. A modified planar cell with solid electrolyte (1), anode (3) and cathode (2), wherein solid electrolyte (1), anode (3) and cathode (2) form a corrugated plate (4), characterized in that the corrugated plate (4) consists of corrugations (5), which form channels in the form of isosceles trapezoids of equal height without a greater lower base for one reagent and channels in the form of inverted isosceles trapezoids without a greater upper base for another reagent.

2. The modified planar cell, as claimed elsewhere herein, with solid-oxide electrolyte (1), gas diffusing anode (3), cathode (2), metal or oxide current path and current gas supply duct, characterized in that
a supporting solid electrolyte (1) of the cell is provided in the form of a corrugated plate (4), consisting of corrugations (5),
corrugations (5) of plate (4), in cross-section, have the form of an isosceles trapezoid without a greater lower base (6) of equal height, with apertures (9), in which apertures (9) are made on one side at a top of each corrugation (5) to feed one of the reagents, for example, fuel in case of the fuel cell,
corrugations (5) are interconnected at their base to form gas space channels (14) of the cell provided in the form of inverted isosceles trapezoids without a greater upper base, while an angle α at their lesser base equals to 0.1 to 89.9°,
the corrugated plate (4) is connected to two opposite walls (7), front and rear ones, arranged perpendicularly to corrugations (5) of the plate (4) of equal height and having apertures (8),
apertures (8) of one wall (7) supply a second reagent, for example, air in case of the fuel cell, into each channel of near-electrode space in the form of inverted isosceles trapezoids without a greater upper base, while apertures (8) of another opposite wall (7) are for hypoxic mixture removal,
the corrugated plate (4) of supporting solid electrolyte (1) is coated with one electrode, for example, nickel-cermet anode (3) in the case of a fuel cell, from a side of gas space channels (14), which, in cross-section, represent an isosceles trapezoid without a greater lower base,
the plate (4) is coated with a second opposite electrode, for example, cathode (2) based on strontium lanthanum manganite, from a side of the gas space channels (14) of near-electrode space, provided in the form of inverted isosceles trapezoids without a greater upper base,
the metallic box-like gas supply duct (17) with a number of apertures (20) leads reagents and removes reaction products, in which case the width and length of the gas supply duct coincide with those of the cell,
these apertures (20) are aligned with apertures (9) at the top of the corrugations (5) of the cell, in cross-section, having the form of an isosceles trapezoid without a greater lower base, and are hermetically connected with corrugations along the perimeter of apertures (20),
a gas-tight space is formed in the planar cell for a reagent passing through the metallic box-like gas supply duct (17), for its uniform distribution over gas space channels (14) and for exhaust gas coming out through a similar output gas manifold (16), rotated by 180° in relation to a vertical axis, and hermetically connected with a ceramic part along the perimeter, and
in this case, flat surfaces of gas manifolds (16) having apertures (20) are connected with electrodes and simultaneously function as current manifolds, while the metallic box-like gas supply ducts (17) are current collectors of the planar cell.

3. The modified planar cell, as claimed elsewhere herein, with solid-oxide electrolyte (1), gas-diffusion anode (3), gas-diffusion cathode (2), metal or oxide current path and current gas supply duct, characterized in that
the supporting porous anode (3) of the planar cell is provided in the form of a corrugated plate (4) composed of corrugations (5), in cross-section, having the form of an isosceles trapezoid without a greater lower base (6) of equal height,
the corrugations (5) have apertures (9) on one side at the top of each corrugation (5) to feed a reagent, for example, fuel in case of the fuel cell,
the corrugations (5) are interconnected at the base to form gas spaces of the planar cell in the form of inverted isosceles trapezoids without a greater upper base,
angle α at the lesser base is 0.1 to 89.9°,
in this case the corrugated plate (4) is connected with two opposite walls (7), the front and rear walls, from material compatible with other components,
these walls (7) are arranged perpendicularly to the corrugations (5) and have the same height as the corrugations and apertures (8), in which case one wall (7) supplies a second reagent, for example, air in case of the fuel cell, into each channel in the form of inverted isosceles trapezoids without a greater upper base,
a near-electrode space and opposite rear wall (7) are for hypoxic mixture removal,
on one side of the gas space channels constituting, in cross-section, an isosceles trapezoid without greater lower base, the supporting plate (4) of porous anode (3) on the side of the corrugations (5), is coated with at least two layers, namely: first, with a thin layer of gas-tight solid electrolyte (1), and then with another porous gas-diffusion electrode, for example, cathode (2) based on strontium lanthanum manganite in case of the fuel cell, with possibility of gas-tight connection and sealing around apertures (8) of the corrugations (5) with input gas manifold (16) and along the perimeter of electrochemical part with an output gas manifold (16),
metallic box-like gas supply duct with a row of apertures leads reagents and removes reaction products, in which case the width and length of the gas space channels coincide with the width and length of the planar cell, and its apertures are aligned with apertures at the top of the corrugations of the planar cell,
the cells consist of channels, in cross-section, having the form of an isosceles trapezoid without a greater lower base, in which case the gas space channel apertures form a gas-tight near-electrode space in the planar cell for fuel passing through the metallic box-like gas supply duct (17), uniform distribution over the channels, as well as for reaction products coming out through a similar output gas manifold (16),
output gas manifold (16) is rotated by 180° in relation to input gas manifold (16) and vertical axis,
flat surfaces of gas manifolds (16), having apertures (20), are connected with electrodes and simultaneously function as current manifolds, and
the metallic box-like gas supply ducts (17) are used as current collectors of the planar cell.

4. The modified planar cell, as claimed elsewhere herein, with solid oxide electrolyte (1), gas-diffusion anode (3), gas-diffusion cathode (2), metal or oxide current path and current gas supply duct, characterized in that
the supporting porous cathode (2) of the planar cell is provided in the form of a corrugated plate (4),
the corrugated plate (4) consists of corrugations (5) forming channels which, in cross-section, constitute an isosceles trapezoid without a greater lower base (6) of equal height with apertures on one side at the top of each corrugation to a reagent, for example, air in case of a fuel cell,
the corrugations (5) are interconnected at the base to form a near-electrode gas space of the planar cell from the channels in the form of inverted isosceles trapezoids without a greater upper base,
angle α at a lesser lower base is 0.1 to 89.9°,
in this case the corrugated plate (4) is connected with two opposite front and rear walls (7) perpendicular to the corrugations (5) of equal height and having apertures,
the front wall is used to supply a second reagent, for example, fuel in case of the fuel cell, into each channel in the form of inverted isosceles trapezoids without a greater upper base in a near-electrode space, while another opposite rear wall is used to remove reaction products,
in this case, the corrugated plate (4) of a supporting porous cathode (2) on a corrugation side (5) consists of channels, in cross-section, having the form of an isosceles trapezoid without a greater lower base, which is first coated with a thin layer of gas-tight solid electrolyte (1), and then with another porous gas-diffusion electrode, for example, nickel-cermet anode in case of the fuel cell, with possibility of a gas-tight connection and a sealing around apertures (8) of corrugations (5) with an input gas manifold (16) and along the perimeter of an electrochemical part with an output gas manifold (16),
a metallic box-like gas supply duct with a row of apertures feeds reagents and removes reaction products,
said reaction products are removed from the channels, in cross-section, having the form of an isosceles trapezoid without a greater lower base,
the width and length of the gas space channel coincide with those of the planar cell, while the apertures are aligned with apertures at the bottom of corrugations (5) of the planar cell,
a gas-tight space is formed in the planar cell,
uniform distribution over the channels of the air coming out of the metallic box-like gas supply duct (17) and hypoxic mixture coming through the output gas manifold (16) are achieved,
output gas manifold (16) is rotated by 180° around the vertical axis,
in this case, flat surfaces of gas manifolds (16), having apertures (20), are connected with electrodes and simultaneously function as current manifolds, and
the metallic box-like gas supply ducts (17) are used as current collectors of the planar cell.

5. The modified planar cell, as claimed elsewhere herein, with solid oxide electrolyte (1), gas-diffusion anode (3), gas-diffusion cathode (2), metal or oxide current path and gas supply duct, characterized in that
supporting porous anode current manifold is provided in the form of corrugated plate (4) from channels, in cross-section, having the form of an isosceles trapezoid without a greater lower base of equal height,
apertures are provided on one side at the top of each corrugation (5),
channels are provided to feed a reagent, for example, fuel in case of the fuel cell,
corrugations (5) are interconnected at the base to form the near-electrode gas space of the planar cell from channels in the form of inverted isosceles trapezoids without a greater base,
angle α at the lesser base is 0.1 to 89.9°,
in this respect, the corrugated plate (4) is connected to two opposite front and rear walls (7) from material compatible with other components, in which case these walls (7) are perpendicular to corrugations (5) of the plate (4), having the same height and having apertures (8),
the front wall is intended to feed a second reagent, for example, air in case of the fuel cell, into each channel in the form of inverted isosceles trapezoids without a greater upper base of near-electrode space, while the opposite wall is intended for hypoxic mixture removal,
in this case, corrugated plate (4) of the supporting porous anode current manifold on the corrugation side (5) consists of channels, in cross-section, having the form of an isosceles trapezoid without a greater lower base, and is coated with at least three layers: first, with a thin layer of gas-diffusion anode material, a thin layer of gas-tight solid electrolyte (1), and then with another porous layer of gas-diffusion electrode, for example, a cathode (3) based on strontium lanthanum manganite in case of the fuel cell,
at the same time, there is a possibility of a gas-tight connection and sealing around apertures of corrugations (5) with an input gas manifold (16) and along the perimeter of an electrochemical part with an output gas manifold (16),
metallic box-like gas supply duct with a row of apertures feeds reagents and removes reaction products,
the width and length of the gas space channel coincide with those of the planar cell,
the apertures of the gas space channel are aligned with apertures at the top of the corrugations (5),
the channels, in cross-section, represent an isosceles trapezoid without a greater lower base,
these apertures form a gas-tight near-electrode space in the planar cell for fuel coming through the metallic box-like gas supply duct (17), said fuel's uniform distribution over the channels and reaction products coming out through a similar output gas manifold (16) rotated by 180° around the vertical axis,
in this case flat surfaces of gas manifolds (16), having apertures (20), are connected with electrodes which simultaneously function as current manifolds, and
the metallic box-like gas supply duct (17) are used as current collectors of the planar cell.

6. The modified planar cell, as claimed elsewhere herein, with solid oxide electrolyte (1), gas-diffusion anode (3), gas-diffusion cathode (2), metal or oxide current path and electron-conducting gas supply duct, characterized in that
the gas supply duct for loss reduction and improvement of current collection uniformity from the cell is provided in the form of a thick electron conducting plate having a width and length equal to those of the cell,
in this respect the plate has a common aperture along one side which is connected with a row of apertures that are aligned with apertures at the top of the cell corrugations, and are hermetically connected with these apertures along a perimeter, in which case the top of the corrugations (5), in cross-section, represents an isosceles trapezoid without a greater lower base (6) for input of one of the reagents,
the gas supply duct for reaction products removal is preliminarily rotated by 180° in relation to a vertical axis, and hermetically connected along a perimeter of a lower electrochemical part of the cell,
the input manifold (16) surface, facing the electrochemical part of the cell, has a protective coating, for example, from manganese-cobalt spinel, and is connected with cathode (3) through material of cathode contactol,
the output manifold (16) surface, facing an electrochemical part, is connected with anode (3) through material of anode contactol, and functions as a current collector, and
the metallic box-like gas supply ducts (17), connected with common apertures, for reagent supply and removal within the manifolds (16) are arranged on any lateral side or on the front and rear sides of the cell.

7. A battery formed from planar cells with solid oxide electrolyte (1), gas-diffusion anode (3), gas-diffusion cathode (2), metal or oxide current path and current gas duct, characterized in that
the cells are connected by upper and lower surfaces of the corrugated working section in series by a current through the flat plates of the current path,
the width and length of the flat plate are the same as those of the cell,
apertures are aligned with apertures (20) at the top of the corrugations (5) of the cell, in cross-section, having the form of an isosceles trapezoid without a greater lower base (6), while during assembly, a gas-tight space is formed in each cell for a reagent coming into the battery along an assembly axis through an input gas manifold (16),
the exhaust gases come out through an output gas manifold (16) perpendicular to the assembly axis inside each cell and along the assembly axis,
input gas manifold (16) ensuring such flow is connected through small apertures with apertures in the corrugations, in cross-section, having the form of an isosceles trapezoid without a greater lower base and an upper surface of the upper cell, and hermetically connected from the top of the corrugations (5),
the cell walls, in cross-section, having the form of an isosceles trapezoid without a greater lower base, are arranged opposite to apertures and along a perimeter of an upper cell bottom, hermetically connected with the current path plate, in which case the plate is rotated by 180° along a battery assembly axis in relation to small apertures of the upper cell,
then each subsequent cell and current path are also rotated by 180° along the battery assembly axis in relation to previous cells, in which case, each current path is hermetically connected by one side along a perimeter of each small aperture, and is not hermetically connected at the opposite side, while the another side is hermetically connected along the perimeter with the cell perimeter,
the end lower cell is connected with output gas manifold (16) for exhaust gases in the same way, in which case the second reagent flow is distributed in the form of parallel flows along all the gas channels in the form of inverted isosceles trapezoids without a greater upper base along all the cells and battery,
the metallic box-like gas supply ducts (17) in each box-like gas manifold have an aperture which ensures uniform gas flow distribution, and are electrically connected with the gas-distributing plate and gas manifold box, and
efficient current collection is effected by the power generating battery from the metallic box-like gas supply duct exterior (17).

8. A method of formation of the MPC ceramic blank, in particular a modified planar cell, as claimed at least in one of claims 1-7, with solid electrolyte (1) for example, based on zirconium dioxide YSZ, gas-diffusion anode (3), cathode (2) and current manifold, in which case anode (3) and/or cathode (2) and/or current manifold is supporting, is a hot slip metal mold casting, for example, based on paraffin, characterized in that
to form a layer of the supporting component of the solid oxide fuel cell with a thickness of 300-500 μm, providing mechanical strength, the required amount of the slip, containing powder from the supporting component material, is injected within 0.2-1.0 sec into the mold without prejudice to laminarity requirements to the cast flows.

9. A mold as for casting of the modified planar cell ceramic blank with solid electrolyte (1) based on zirconium dioxide—YSZ, for example, the cell with supporting solid electrolyte (1), with supporting gas-diffusion anode (3), supporting gas-diffusion cathode (2) or supporting gas-diffusion current manifold, using hot slip metal mold casting, for example, based on paraffin, characterized in that
the steel mold for formation of the blank with the MPC channels, in cross-section, having the form of an isosceles trapezoid without a greater lower base (6), and in the form of inverted isosceles trapezoids without a greater upper base, has two groups of rectangular movable plates and two groups of immovable plates,
in this case the plates alternate,
the blanks, moving within the formation zone, are trapezoids in cross-section,
angle α at the lesser base is 0.1-89.9°,
immovable plates along the blank perimeter and the plate on one side of the corrugated blank provide dismountability of the mold, and
the mold is equipped with a mechanism that ensures retrieval of movable plates from the cast and a threaded handle for mold dismantling.

10. An increased capacity battery, consisting of modified planar cell batteries with supporting solid oxide electrolyte (1), gas-diffusion anode (3), gas-diffusion cathode (2), electron conducting metal or oxide current path (22), as claimed in 19, and assembled in the same way as the battery from the single modified planar cells, as claimed in 17 and/or 18, characterized in that
the working part of the battery electrolyte (1) is provided in the form of corrugated plate with electrodes of one polarity applied from above and with electrodes of another polarity applied with a shift from below, connected to the battery with the current path (22) and formed on the plate in corrugations, in cross-section, having the form of an isosceles trapezoid without a greater lower base for one gas reagent, and the corrugations, in cross-section, having the form of an inverted isosceles trapezoid without a greater upper base for another gas reagent, in which case, angle α at the lesser base is 0.1-89.9°,
in this case, the corrugated plate is connected by two opposite walls, front and rear, from electric insulating material, having corrugations of equal height and apertures (8), for input and removal to each channel in the form of inverted isosceles trapezoids without a greater upper base of one reagent, for example, oxidant (air) in case of the solid oxide fuel cell, and for hypoxic mixture removal,
in which case the corrugated plate itself has apertures for another reagent input, for example, hydrogen fuel, when operating as a solid oxide fuel cell, into each channel in the form of isosceles trapezoids without a greater lower base, in which case these apertures are arranged at upper bases near one of the junction walls,
the batteries are interconnected with a flat junction plate interconnect from an electric insulating material, the width and length of which are equal to those of the battery, in which case the junction plate has a row of apertures which are aligned with apertures at the top of battery corrugations,
the end batteries are connected with ceramic gas space channels—gas manifold from electric insulating material—with a row of apertures which are aligned with apertures at the top of plate corrugations near one of the walls, thus ensuring that the fuel reagent is fed and reaction products are removed,
the gas vent is rotated by 180° around a vertical axis in order to ensure uniform distribution of fuel passing through the channels, in each subsequent component assembly in series: the gas space channel, battery, junction plate, battery, junction plate, battery during assembly and sealing of the increased capacity battery,
in which case the series electrical connection of adjacent batteries on the corrugated plate is effected by means of contacts on lateral walls (15.2, FIG. 7).
